(19) United States
(12) Patent Application Publication
(10) Pub. No.: US 2007/0221431 A1
(43) Pub. Date: Sep. 27, 2007

(54) Auxiliary power unit for a vehicle

(75) Inventor: Arthur E. Hirsh, Paris, IL (US)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: Dunamis Power Systems, Inc., Danville, IN (US)

(21) Appl. No.: 11/386,964

(22) Filed: Mar. 22, 2006

(51) Int. Cl. B60K 5/00

(52) U.S. Cl. 180/299

(57) ABSTRACT

An auxiliary power system is provided for a vehicle having a frame with two longitudinal beams, in which the system includes an auxiliary power unit (APU) mounted on a support frame that is pivotably mounted to the vehicle frame to permit pivoting in a vertical plane. The support frame further includes The support frame further includes a suspension system at an intermediate location between the pivot mount and the APU to help isolate the APU from the effects of road vibration. The APU itself is mounted on rollers so that the APU can be slid out of its housing for access and/or removal. The housing door is configured to provide a rolling surface onto which the APU can be moved when the door is open. The APU includes an engine exhaust heat exchanger that scavenges engine heat to heat the vehicle. A rotating cleaning auger is mounted within the heat exchanger to clean the surfaces of debris left by the engine exhaust gases.

### BACKGROUND OF THE INVENTION

The present invention relates to auxiliary power units, and especially units for use with vehicles, such as long-haul trucks.

Large tractor trucks typically have air-conditioning systems similar to automobiles in which the truck engine drives a compressor that compresses refrigerant and delivers it to a condenser. An interior fan flows air through an evaporator into the interior of the vehicle. The condenser is cooled by the main engine fan, which also flows air through the engine radiator.

For heating, a heater coil or element is mounted in the vehicle in communication with the radiator via hoses. A portion of the hot engine coolant flows through the heater coil. The interior fan flows air through the heater coil to heat the interior of the vehicle.

Standards in the trucking industry require a certain amount of rest time for long haul truckers. Consequently, many trucks have sleeper compartments attached to the cab for allowing the driver to rest. For heating and cooling during this time, the operator traditionally continues to operate the main truck engine at idle in order to run the air-conditioner or heater. Often, the sleeper compartment will have a sleeper compartment evaporator, heater coil and blower. The evaporator in the sleeper compartment is in parallel with the truck cab evaporator, and the heater in the sleeper compartment is in parallel with the truck cab heater. The main air conditioner compressor and condenser supply refrigerant to the sleeper compartment evaporator, which means that the truck engine must be operated.

While idling, the main engine generates far more power than is needed for heating and cooling. Running the engine at idle for these extended times unnecessarily consumes considerable fuel while the vehicle is stopped, burning about one gallon of diesel fuel per hour. Moreover, running the engine at idle increases vehicle emissions, and causes wear and tear on the engine. Thus, the yearly cost of operation and maintenance of the truck can be increased by many thousands of dollars.

More significantly, over twenty states in the U.S. have “no idle” laws that limit the length of time that a truck can run at idle to ten minutes or less. The U.S. government has mandated a no-idle law to go into effect in January, 2007, with potential fines as high as $10,000 for idling beyond the prescribed time. Federal laws also mandate that drivers cannot operate their truck for more than 14 hours in a day and require a time span of ten hours per day where the truck engine must be turned off. With these regulations, it is apparent that the traditional practice of running sleeper air conditioning by idling the truck engine can no longer be continued.

One approach to eliminating the need to idle the truck engine has been to provide a generator mounted to the trucks for generating 110-120 volt AC power. An auxiliary engine, normally diesel, is located in a compartment along with a generator. The generator drives a separate 110 volt air-conditioning unit that is mounted in the sleeper compartment or cab. For heat, an electrical resistance element is typically employed, or the air-conditioner may be operated as a heat pump, which consumes a considerable amount of power.

Another approach for heating and cooling while the truck is stopped is to utilize a 110 volt air conditioning unit and a power cord that extends to a power service receptacle at a rest stop. Currently many rest stops, however, do not have such provisions for connecting a vehicle to electrical power. Although more rest stops will be provided with electrical access upon the advent of the 2007 federal regulations, the cost to the owner/operator of the necessary electrical equipment can be high. Moreover, this approach assumes that the driver is able to find a rest facility with electrical service.

Auxiliary power units (APUs) are known that use an auxiliary engine to directly drive an auxiliary air conditioner compressor. An auxiliary condenser is mounted in the auxiliary housing, while an auxiliary evaporator, heating element, and blower are mounted in the sleeper compartment, typically under the bunk or bed. The auxiliary blower discharge is independent of the ducts of the rear sleeper compartment air conditioning unit. The auxiliary engine normally also drives an alternator for supply DC power to the blower and other DC equipment. The concept behind these APUs is simple—a nine horsepower engine can satisfy all of the air conditioning and electrical needs for a sleeper cab more efficiently, more cheaply and with fewer emissions than a 500 horsepower truck engine.

One problem with many currently available APUs is that the unit is integrated directly into the existing truck heating and cooling systems. This makes servicing of the APU difficult, and more importantly may void the warranty of the truck engine. Another problem with current APUs is that they need frequent maintenance, in many cases requiring servicing every 100-150 hours even though the truck engine may only need servicing every 1000 hours of operation. A further problem with many APUs is that they are not durable enough to withstand the continuous shock and vibration to which the typical long-haul truck is exposed.

### SUMMARY OF THE INVENTION

In order to address the industry needs for an improved APU, the present invention contemplates an auxiliary power system for a vehicle having a frame with two longitudinal beams, in which the system includes an auxiliary power unit (APU) mounted on a support frame that is pivotably mounted to the vehicle frame to permit pivoting in a vertical plane. The support frame further includes a suspension system at an intermediate location between the pivot mount and the APU to help isolate the APU from the effects of road vibration. The APU itself may be mounted on rollers so that the APU can be slid out of its housing for access and/or removal. The housing door is configured to provide a rolling surface onto which the APU can be moved when the door is open.

In another feature, the APU includes an engine exhaust heat exchanger that scavenges engine heat to heat the vehicle. A rotating cleaning auger is mounted within the heat exchanger to clean the surfaces of debris left by the engine exhaust gases.

The APU of the present invention includes an electrical supply circuit that includes a generator and/or alternator for providing electrical current to the vehicle. As the electrical demand increases, the engine power output demand increases, which causes the engine to run hotter. This increase in engine operating temperature results in an increase in heat production through the APU heat exchanger.

It is one object of the present invention to provide an auxiliary power generation system for vehicles that is easier to access for repair or replacement. Another object is to provide an APU that makes highly efficient use of the power generated by the APU engine, for heat generation for the vehicle as well as for electrical power generation. Other objects and benefits of the invention will become apparent from the following written description and accompanying figures.

### DESCRIPTION OF THE FIGURES

FIG. 1 is a side view of a long-haul truck with an auxiliary power unit (APU) system according to one embodiment of the present invention mounted thereon.

FIG. 2 is an enlarged front perspective view of the APU system according to the present invention mounted to the truck frame.

FIG. 3 is an enlarged rear perspective view of the APU system according to the present invention mounted to the truck frame.

FIG. 4 is an enlarged front perspective view of the APU system shown in FIG. 2 with the APU shown extended from within its housing.

FIG. 5a is a side view of the APU system shown in FIG. 4 with the APU extended from its housing.

FIG. 5b is a side view of the APU system shown in FIG. 5a, with the APU positioned within the housing, but with the housing itself removed for clarity.

FIG. 6 is a rear perspective view of the APU system separate from the truck and with the housing removed.

FIG. 7 is a side partial view of the APU system shown in FIG. 6.

FIGS. 8a, 8b are side cross-sectional views of a heat exchanger of the APU system shown in the prior figures.

FIG. 9 is an enlarged side view of a pivot mount of the support frame for the APU system shown in FIGS. 2-3.

FIG. 10 is a schematic representation of a dual alternator feature in one embodiment of the APU system of the present invention.

### DESCRIPTION OF THE PREFERRED EMBODIMENTS

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

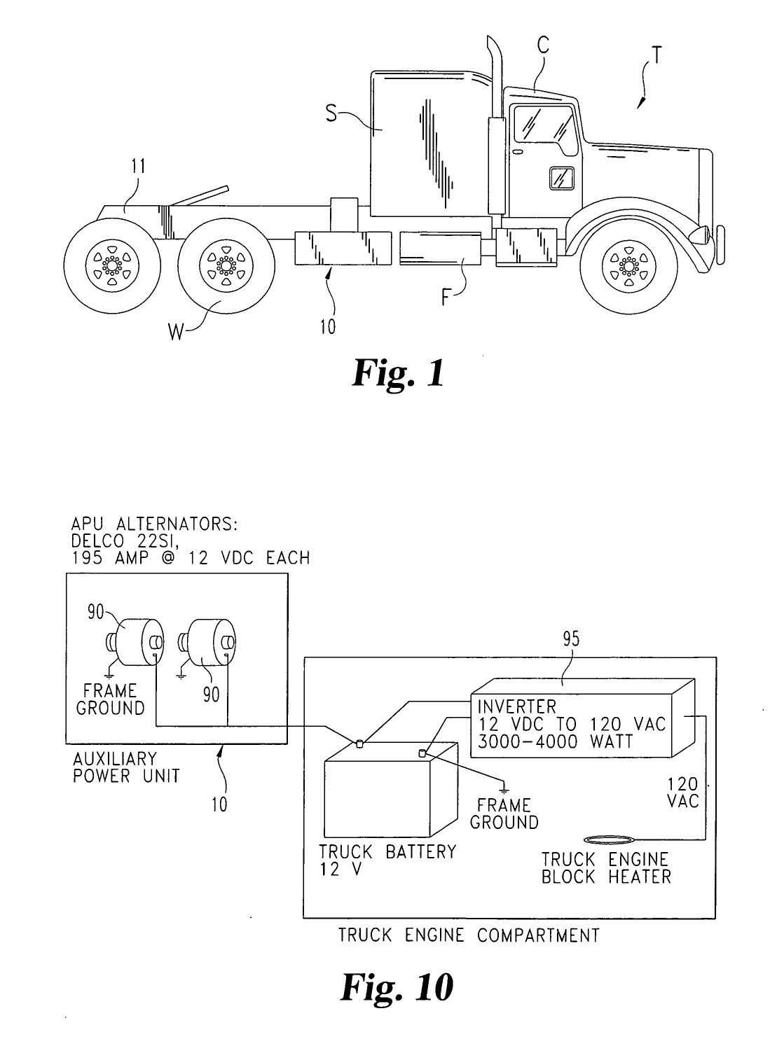

The present invention contemplates an auxiliary power system for a long-haul truck, such as the truck T shown in FIG. 1. The truck T includes a cab C to which a sleeper cabin S is connected. The truck includes a frame 11 that supports the cab and sleeper cabin, as well as a fuel tank. The auxiliary power unit (APU) system 10 of the present invention is configured to be supported by the existing truck frame 11, preferably between the fuel tank F and the wheels W.

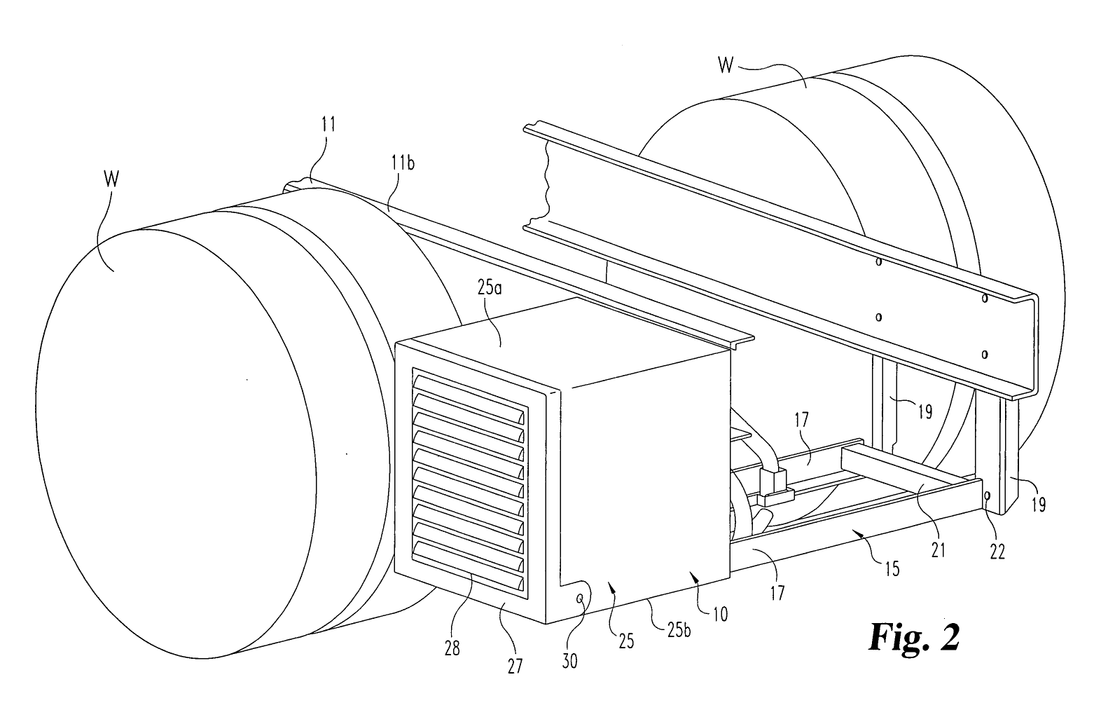

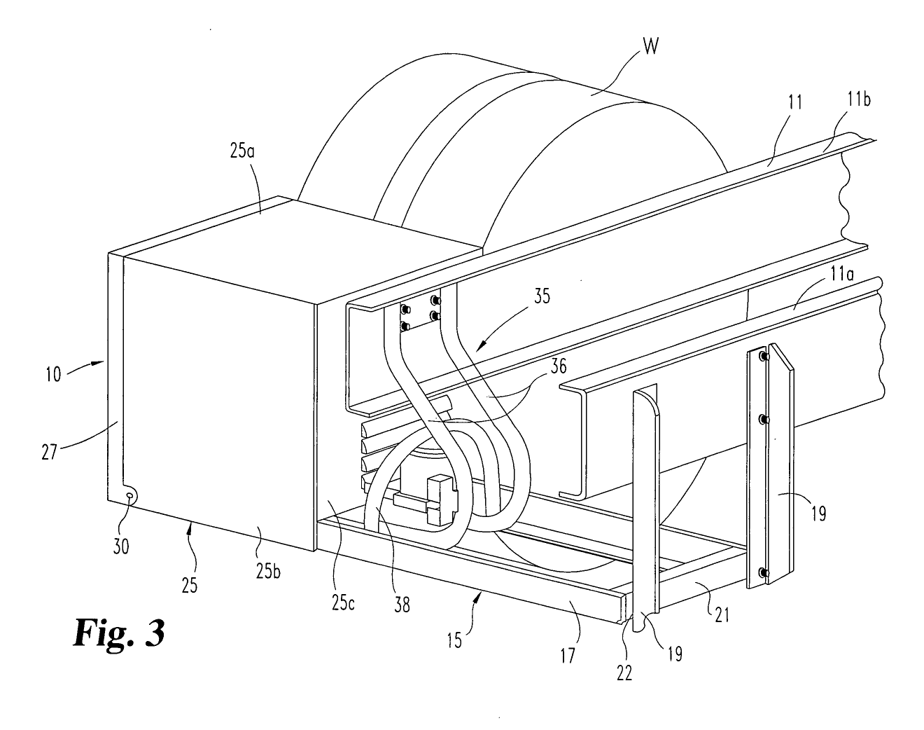

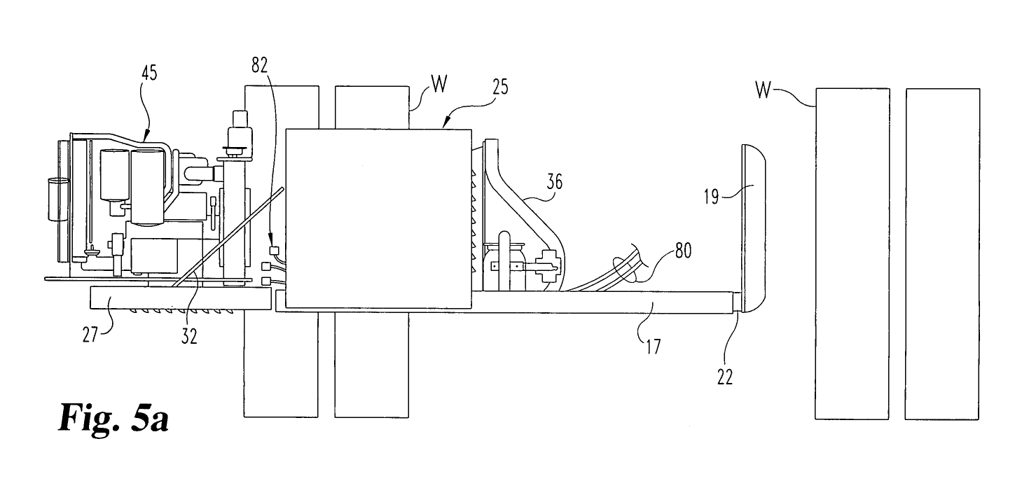

The APU system 10 of the present invention includes a support frame assembly 15 that is used to mount the system to the vehicle frame 11, as shown in FIGS. 2-3. The support frame assembly 15 includes a pair of support members in the form of horizontal rails 17 that are sized to span from one side beam 11a of the vehicle frame 11 to and beyond the opposite side beam 11b. In the preferred, embodiment, the horizontal rails extend to a location adjacent the outboard wheel W, as best seen in FIG. 5b. An end beam 21 is connected between the ends of the two rails 17 and is used to anchor a pair of vertical beams 19. The vertical beams are attached to the side beam 11a of the vehicle frame using suitable mechanical fasteners, such as a bolt array.

In accordance with one aspect of the invention, the vertical beams 19 are connected to the end beam 21 by a pair of pivot mounts 22. The pivot mounts 22 are configured to permit relative movement between the horizontal rails 17 and the vertical beams 19 so that the rails 17, and consequently the entire APU system 10, can flex relative to the vehicle frame 11. The pivot mounts 22 are configured to permit flex or pivoting of the rails 17 and system 10 in a vertical plane, which coincides with the degree of freedom of typical road vibration and shock.

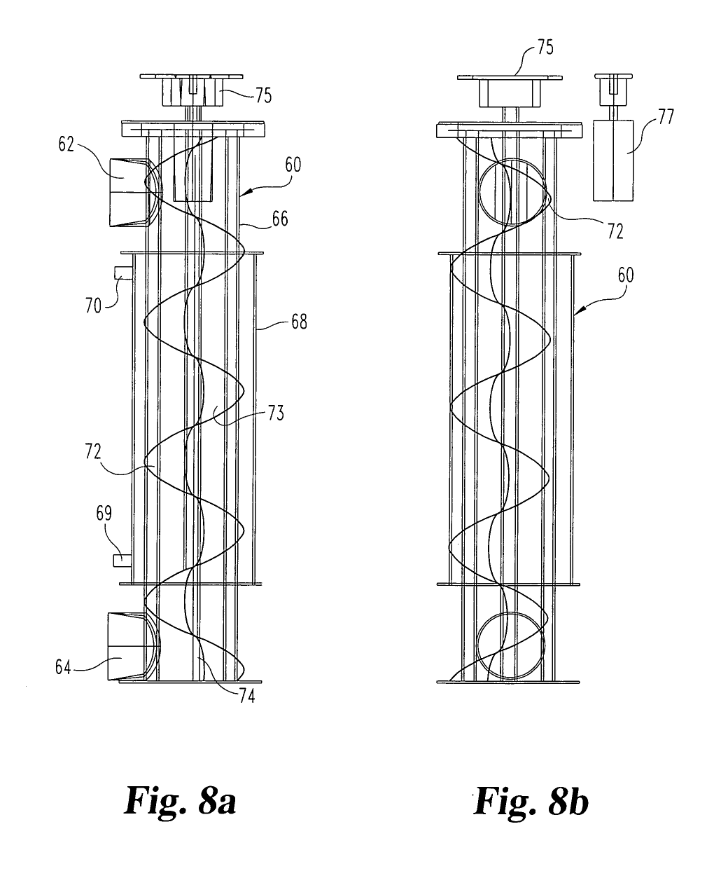

In one specific embodiment, the pivot mounts 22 are configured to also permit pivoting of flex in a horizontal plane, corresponding to fore-aft vibration or shock along the longitudinal axis of the truck frame 11, such as might be experienced during braking or low-speed gear changes. In this embodiment, the pivot mounts may include a ball-end fastener 23 mounted to each vertical beam 19 that fits within a corresponding spherical bearing 24 fastened to the end beam 21, as shown in FIG. 9. In another specific embodiment, the pivot mounts 22 are configured to permit pivoting only in the vertical plane, and not in the horizontal plane. In this specific embodiment, the interface between the fastener 23 and the bearing 24 may be modified accordingly to limit the degrees of freedom of movement of the frame assembly 15 relative to the vehicle frame 11. The interface may also be configured to permit lateral movement of the APU support frame relative to the vehicle frame, such as by the introduction of a resilient bushing between the bearing 24 ad the vertical beam 19.

As thus far described, the support frame 15 is cantilevered from one beam 11a of the truck frame 11, and is supported to permit flexing or pivoting in at least a vertical plane relative to the truck. In order to fully support the APU system 10 and accommodate a suitable amount of flex of the support frame 15, the frame assembly 15 further includes a suspension system 35 that is connected between the horizontal rails 17 and the opposite beam 11b of the truck frame, as seen in FIGS. 3, 6 and 7. The suspension system 35 is configured to control and dampen the vertical pivoting of the APU system 10. Most preferably, the suspension system 35 is configured to prevent resonant vibration of the APU system. In one specific embodiment, the suspension system is configured to set the natural frequency to a frequency range that is not likely to be excited by normal road travel vibration. Moreover, the suspension system may be configured to critically dampen the motion of the APU system 10.

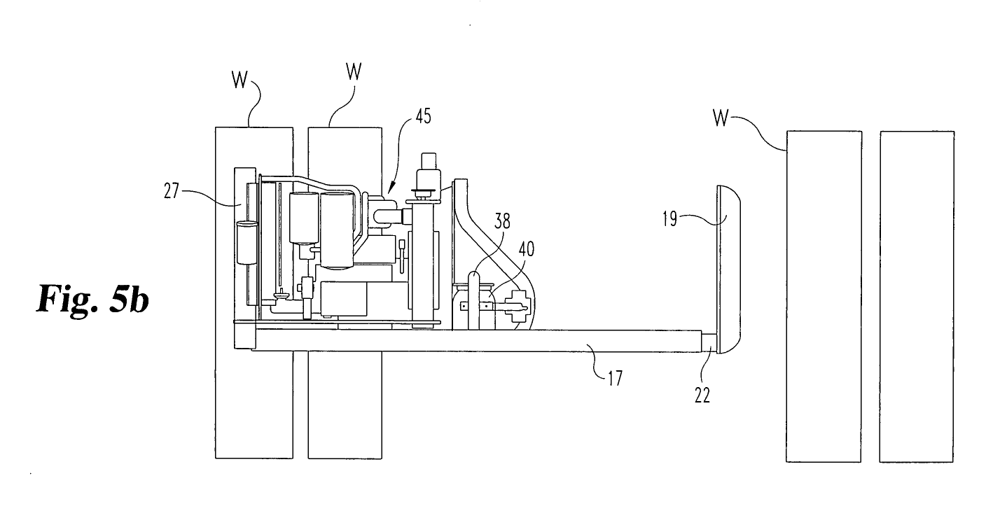

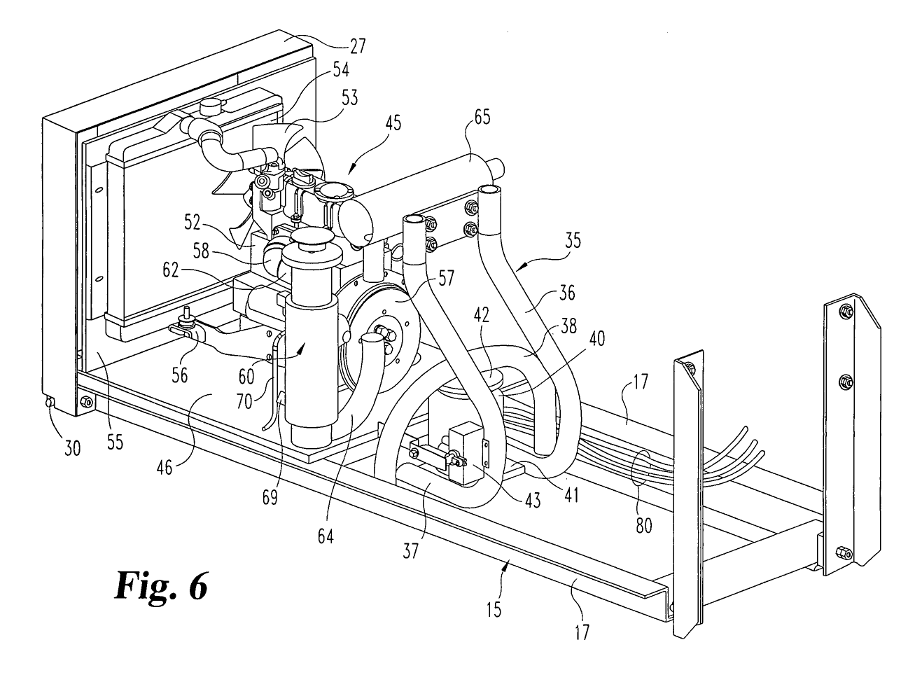

In the illustrated embodiment, the suspension system 35 includes curved frame mounts 36 that are mounted to the beam 11b of the truck frame, as best seen in FIG. 7. The frame mounts are curved from the vertical connection to the truck frame beam 11b to a horizontal portion 37 situated between the horizontal rails 17, as shown in FIG. 6. These horizontal portions 37 are flanked by an inverted U-shaped support frame mount 38 that spans and is attached to the two horizontal rails 17, such as by welding or other mechanical fixation. The horizontal portions 37 of the truck frame mounts 36 support a lower plate 41, while the support frame mount 38 supports an upper plate 42. The lower and upper plates are connected to an absorber element 40 that is configured to resiliently control the vibration of the APU system 10. In one preferred embodiment the absorber element 40 is an air spring having a relatively low spring rate to produce a low natural frequency for the cantilevered APU system. A pneumatic controller 43 may be provided for the air spring 40 to maintain an appropriate air pressure within the air spring, and optionally to permit adjustment of its spring rate.

The air spring 40 is sandwiched between the lower and upper plates 41, 42. The truck frame mounts 36 preferably provide a base for supporting the air spring so that the suspension system will bottom on a truck frame supported portion in the event of a malfunction. The arrangement of the truck frame mounts 36 and the support frame mount 38 allows the suspension system 35 to be supported by the beam 11b of the truck frame as close as possible to the cantilevered weight of the APU 45 (FIG. 7) supported by the horizontal rails 17. Thus, the curved shape of the truck frame mounts 36 provides clearance for the support frame mount 38 and the air spring 40. In addition, the curved shape of the truck frame mounts adds some flexibility to the suspension system in both vertical and horizontal degrees of freedom.

In the illustrated embodiment, the absorber element 40 is an air or pneumatic spring. Other spring-like elements are also contemplated, such as a spring shock absorber or a load-leveler shock absorber, or a combination of mechanical and air spring. In other embodiments, resilient bushings may be utilized. It is one important goal of the absorber element 40 to prevent resonant oscillation of the system 10. Another goal may be to reduce or dampen the movement of the cantilevered system. Thus, absorber elements that can accomplish these objectives may be utilized in lieu of the air spring of the illustrated embodiment.

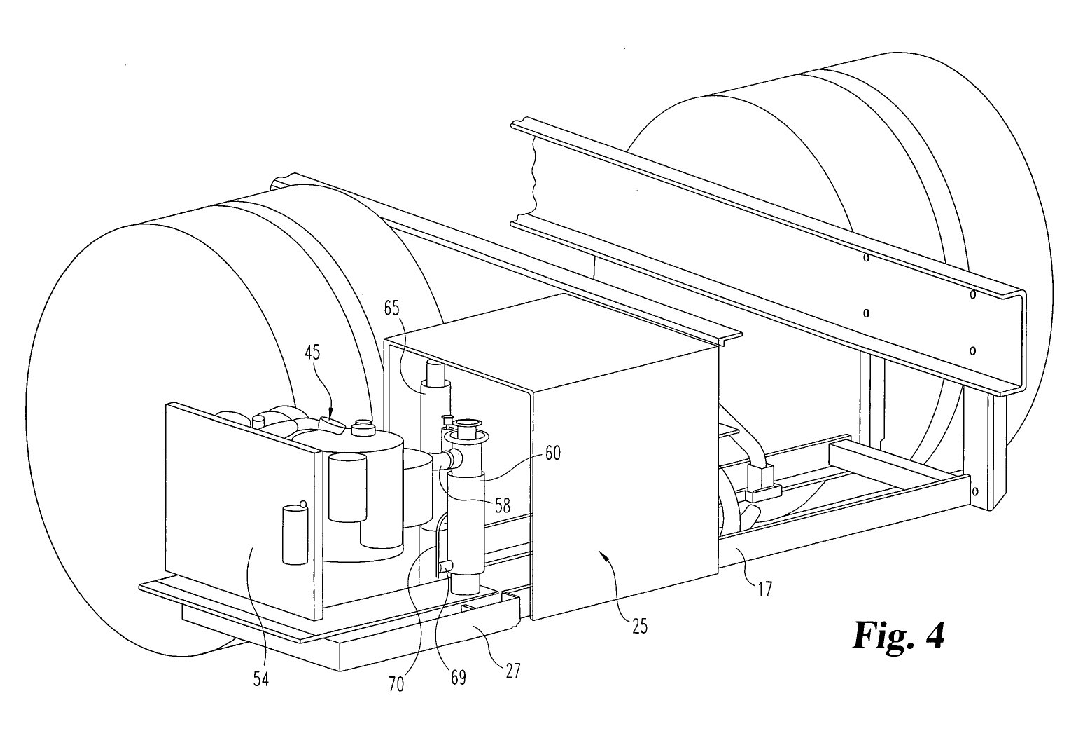

One problem with prior APUs has been serviceability, or more particularly access for service. In order to address this problem, the APU system 10 of the present invention provides a slide out APU 45, illustrate din FIGS. 4-7. In the preferred embodiment, the APU 45 is mounted on a plate 46. Mounts 47 are fixed to the bottom of the plate and are configured to carry at least four mobile elements 48, as shown in FIG. 7. The mobile elements are configured to allow the support plate 46 to move relative to the support frame assembly 15, and particularly the horizontal rails 17. In one embodiment, the mobile elements 48 may include a ball bearing 49 that can roll along the web 18 of the rails 17. Other configurations are possible, such as a roller, wheel or low-friction skid. The important object for the mobile elements 48 is that they allow the APU 45 to be easily moved out of the housing 25, as depicted in FIGS. 4 and 5a.

The housing 25 includes an access door 27 that is pivotably mounted to the housing at a pivot mounts 30 (FIG. 6). Each pivot mount is preferably attached to the end of each horizontal rail 17 and are configured so that the access door 27 can pivot to an orientation that is essentially coplanar with the rails 17, as best seen in FIG. 5a. The pivot mount may be configured to support the access door 27 in this horizontal coplanar position. Preferably, a tether 32 is provided that is connected between the access door 27 and the housing 25 to support the door in the horizontal position. The tether may be a cable on either side of the door or may be a rod slidably mounted to the housing.

When the access door 27 is extended, as shown in FIGS. 4 and 5a, the APU 45 may be conveyed out of the housing 25 and onto the door. Thus, the mobile elements 48 are configured to travel along the inside surface of the door 27, and this inside surface is arranged to provide a smooth transition to and from the web 18 of the horizontal rails 17. It can therefore be appreciated that the horizontal rails and access door provide an easy way to move the APU 45 into a more accessible position for service, repair or replacement. With respect to the replacement aspect, the APU system 10 preferably includes quick-connect fittings for hoses and wires running to and from the APU 45 and the truck. Thus, a hose and wire bundle 80 (FIGS. 5a, 6) may be supported within the support frame assembly 15. The ends of the hoses and wires adjacent the APU 45 may be provided with quick-connect couplings 82 that allow the hoses and wires in the bundle 80 to be easily connected to and disconnected from corresponding wires and hoses of the APU 45. The quick disconnect couplings 82 may be of any suitable type for the particular hose or wire. For instance, the fluid couplings may be Parker Hannifin Stratoflex quick disconnect couplings and the electrical couplings may be a Tyco-AMP barrel-type quick coupling. In this way, the APU 45 can be disconnected and removed for servicing and/or replacement. The support plate 46 on which the APU is mounted is preferably configured so that the plate and APU can be lifted off the open access door 27. The ball bearing configuration illustrated in FIG. 7 allows the APU and plate to be lifted upward off the access door 27, once the couplings 82 have been disconnected. A new, refurbished or newly serviced APU can then be placed on the open access door, coupled to the cable and tubing bundle 80 through the quick connect fittings 82 and pushed back into the housing 25.

As thus far described, the APU system 10 of the present invention stably supports an APU on the vehicle frame 11 while reducing the effects of road vibration on the unit. The system also permits ready and easy access to the APU and even removal of the unit. For the purposes of these features of the invention, the APU 45 itself can be of many types, provided that the APU is sized to fit within the available envelop on the truck frame 11 between the fuel tank F and wheels W (FIG. 1).

In a further aspect of the invention, an improved auxiliary power unit 45 is provided. The APU 45 is a self-contained unit capable of providing heating, cooling and electrical power to the sleeper cabin S of the truck T. The heart of the APU is an internal combustion engine 52, which is most preferably a small two cylinder diesel engine so it can run on the diesel fuel used for the truck engine. In one specific example, the engine is a nine horsepower Kubota diesel engine driving a belt drive pulley 57. The engine drives a cooling fan 53 that flows air across a radiator 54 supported on a vertically mounting plate 55 that is itself mounted on the APU support plate 46. The radiator 54 is arranged in line with the grill 28 of the access door 27 when the door is closed on the housing 25. The engine itself is carried by conventional engine mounts 56 (FIG. 6) that are themselves supported on the plate 46 in a known manner.

The APU of the system 10 powers a heater coil system mounted within the sleeper cabin. The heater coil system relies upon the circulation of a heated fluid, such as water, through a coil situated within the cabin. A blower conveys air across the coil surfaces to transfer heat from the fluid within the coil to the passing air. In one feature of the invention, the fluid flowing through the heater coil is heated through a heat exchanger 60 forming part of the APU 45, as shown in FIGS. 6 and 7. The heat exchanger includes a preferably vertically supported inner tube 66 that includes an inlet fitting 62 and an outlet fitting 64 at its opposite ends. The inlet fitting 62 is coupled to the exhaust manifold 58 of the engine. The outlet fitting 64 is coupled to a suitably sized and positioned muffler 65. The vertical orientation allows particulate matter and condensed water to collect at the bottom of the heat exchanger 60 without interfering with the gas flow through the inner tube.

The heat exchanger 60 further includes a heat transfer jacket 68 concentrically surrounding the inner tube 66 through which the engine exhaust flows. Water is supplied to the jacket 68 at an inlet 69, while the heated water is discharged through an outlet 70. It can be appreciated that the heat transfer jacket 68, inlet 69 and outlet 70 form a closed fluid circuit with the heater coil in the sleeper cabin. This fluid circuit preferably incorporates appropriate quick disconnect couplings 82 at the interface between the APU 45 and the hose and cable bundle 80 that remains with the truck. A water pump (not shown) is driven by the engine 52 and is connected at either the inlet 69 or outlet 70 to continuously convey water through the heat exchanger jacket 68 and the heater coil at the sleeper cabin.

It is contemplated that the heat exchanger 60 is capable of satisfying all of the heating needs for the sleeper cabin. Thus, this aspect of the present invention is operable to scavenge waste heat from the operation of the APU engine 52. A subsidiary benefit is that the heat exchanger 60 reduces the temperature of the engine exhaust gases.

The heat exchanger 60, and more particularly the fluid circuit incorporating the inlet 69 and outlet 70 of the exchanger, may be integrated with a traditional heater coil adjacent the radiator 54. It is also contemplated that either or both the fluid inlet 69 and outlet 70 may be provided with a pressure relief valve to vent excess pressure if the water flowing through the jacket 68 becomes over-heated. In addition, the inlet and/or the outlet may be provided with a flow control valve that is operable to prevent water flow into the heat exchange jacket 68 when scavenge heat is not desired. Thus, when the ambient temperature does not require heat for the sleeper cab, the heat exchanger 60 can be converted into a simple exhaust by draining water from the jacket and closing the fluid inlet/outlet to the jacket.

The heat exchanger 60 utilizes the engine exhaust to perform its function. This exhaust gas may include particulate matter, or yield precipitates or condensates as the gas coils during its travel through the exchanger. This waste material gradually collects within the central tube 66, coating the interior wall of the tube. Over time, this coating leads to deterioration in the heat exchange capability of the exchanger 60. It is therefore important to periodically clean the interior of the central tube 66. While this can be accomplished by removing the heat exchanger 60 and manually cleaning the interior, the present invention contemplates an automatic powered process for cleaning the heat exchanger.

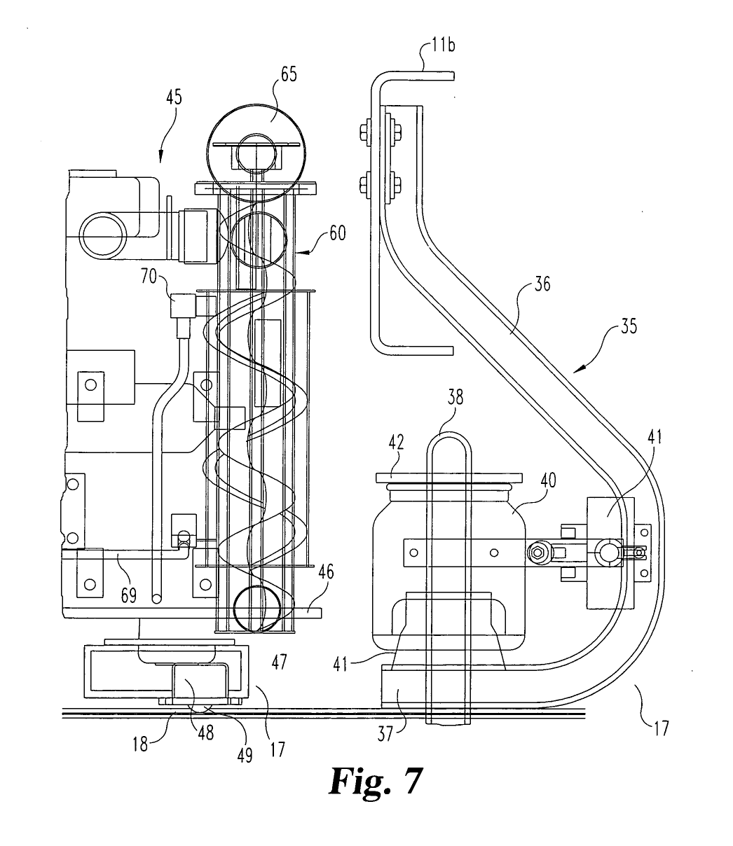

In accordance with one embodiment of the invention, a cleaning auger 72 is rotatably disposed within the central tube, 66, as depicted in FIGS. 8a, 8b. In one embodiment, the cleaning auger 72 optionally includes helical brushes 73 mounted to an axle 74. The axle 74 spans the length of the central tube 66 and extends beyond the top of the tube to mate with a rotation fitting 75. The rotation fitting 75 is driven by an adjacent motor 77 through appropriate gearing. The motor 77 may run continuously when the engine 52 is operating, but most preferably is periodically activated to clean the interior of the central tube 66. This periodic operation may be automatically activated by an on-board controller or may be activated by the driver or service personnel. It is contemplated that the motor 77 is a small DC motor capable of driving the cleaning auger 72 at a slow rate, such as ten rpm or less.

The helical brush 73 includes an array of bristles that preferably span the entire radial distance between the axle and the interior wall of the central tube. The bristles that are sufficiently stiff to scrape material caked on the interior of the central tube. In addition, the array of bristles is sufficiently dense, or closely spaced, to effectively clean the central tube, but is not so dense as to significantly impede the flow of exhaust gas through the heat exchanger 60. Alternatively, the auger 72 may be a helical plate with its edge closely adjacent or slightly contacting the inside of the central tube, preferably provided with apertures to allow gas flow through the auger. It is contemplated that the residue left after cleaning the central tube can be flushed by the flow of exhaust gas exiting the heat exchanger through the outlet 64. Optionally, the outlet 64 may include a residue trap (not shown) that can be opened to remove any particulate matter that is not expelled with the exhaust gases.

As with the typical APU, the APU 45 of the present invention powers an array of components. In particular, the engine 52 is provided with a belt drive pulley 57 that can power a variety of belt-driven components, such as alternators, AC generators and compressors. Thus, an air-conditioning compressor may be driven by the pulley 57. In one optional feature, the engine 52 may drive a generator of known design operable to generate 117VAC current. This AC current may be used to power an engine block heater integrated into the primary truck engine. With this feature, one of the cables in the cable and hose bundle 80 is dedicated to the engine block heater.

In yet another optional feature, the belt drive pulley 57 may drive a circulating pump that is used to pump heated engine coolant through tubes positioned within the diesel fuel tanks. Heat transfer from these tubes keeps the diesel fuel warm and prevents the fuel from gelling in cold weather. Alternatively, the fluid circuit for heating the sleeper cabin may be diverted to supply the heated water to the fuel tank tubes.

The APU 45 of the present invention contemplates optimizing cogeneration—i.e., utilizing the waste heat from the engine to provide heat to the driver. It is known that the heat produced by a diesel engine is directly dependent upon the load demand. About ⅓ of the energy of combustion is converted to mechanical energy to drive the cooling fan 53 and the belt drive pulley 57. Another third does into the engine cooling system as waste heat to be rejected through the radiator 54. The remaining approximate ⅓ of the energy of combustion is typically discharged through the engine exhaust. However, as described above, the engine exhaust is used with the heat from the engine cooling system to provide cabin heating through the heat exchanger 60. Thus, when the engine 52 drives additional electrical components, such as the generator for powering the engine block heater, this added demand on the engine causes it to run hotter, which translates into greater heat output through the engine exhaust that is used to power the heat exchanger 60 for heating the sleeper cabin. It is also contemplated that the generator will also provide electrical power to the cabin to power a refrigerator, cabin lights, a television, a stereo system or other comfort appliances. The electrical power may even be used to power a small space heater to augment the existing heating capacity of the APU system 10 when the outside temperature is very low. Each electrical component increases the electrical requirements from the generator, which increases the demand on the engine of the APU, which then ultimately increases the heating capability of the heat exchanger 60.

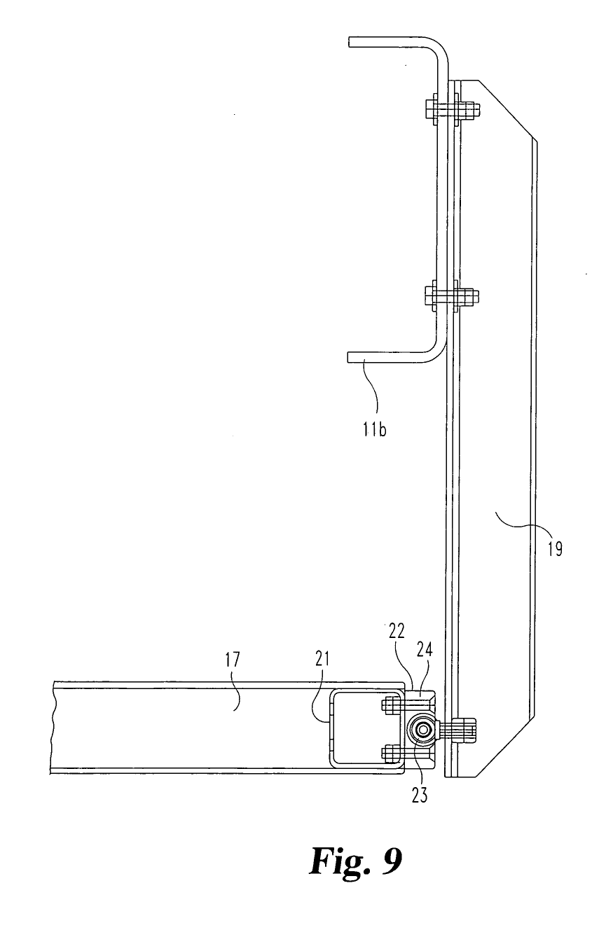

In the embodiment described above, the engine 52 powers a generator for supplying auxiliary electrical power to various components. In an alternative embodiment, the APU system includes single or dual alternators 90, as depicted in the schematic of FIG. 10. A single high output alternator or dual alternators can be used for a low cost high output system. Both alternators are belt driven by the engine 52. The alternators 90 are integrated into the primary truck electrical system, and particularly through the truck battery. In one specific embodiment, the alternators are 12VDC, 195 amp Delco alternators. The alternators are connected to an inverter that converts the 12VDC to 120VAC that can be used to power the cabin comfort appliances and/or the truck engine block heater.

This dual alternator embodiment provides advantages over AC generator systems because the typical generator must be driven at a fixed speed, usually at either 1800 or 3600 rpm, in order to maintain the AC frequency (typically 60 Hz). However, the engine speed at the APU 45 will vary with load demand. The alternators 90 overcome this problem since the DC output does not have a frequency that varies with speed. The inverter 95 is configured to produce a fixed frequency AC signal from the DC input and is not dependent upon the speed of the APU engine 52.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

As a safety option, the APU system 10 may incorporate an automatic shut-off based on various sensors at the APU and in the vehicle. For instance, a CO₂ sensor may be provided within the vehicle or sleeper cabin. The sensor is linked to the engine controls for the APU to shut the engine down when excessive gas levels are sensed.

What is claimed is:

1. An auxiliary power system for a vehicle having a frame with two longitudinal beams, said system comprising:
a support frame including;
a pivot mount at an end thereof, said pivot mount connected to one longitudinal beam of the vehicle frame to permit pivoting of said support frame in a vertical plane relative to the vehicle frame;
at least one elongated support member connected at one end to said pivot mount and extending across the vehicle frame; and
a suspension system connected between the other of the longitudinal beams of the vehicle frame and said at least one support member at an intermediate location between said one end and an opposite end of said at least one support member; and
an auxiliary power unit (APU) supported on said at least one elongated support member between said opposite end and said intermediate location.

2. The auxiliary power system of claim 1, wherein said suspension system includes a spring element.

3. The auxiliary power system of claim 2, wherein said spring element is an air spring.

4. The auxiliary power system of claim 2, wherein said spring element is a shock absorber.

5. The auxiliary power system of claim 4, wherein the shock absorber is a load leveler shock absorber.

6. The auxiliary power system of claim 1, wherein said suspension system and said APU form a cantilevered spring-mass system and said suspension system is calibrated so that said spring-mass system has a pre-determined resonant frequency different from characteristic frequencies of vibration of the truck as it travels over the road.

7. An auxiliary power system for a vehicle having a frame with two longitudinal beams, said system comprising:
an auxiliary power unit (APU);
a pair of elongated rails connected to the vehicle frame and including a portion extending outboard of the vehicle frame; and
at least two mobile elements configured to be movably supported on said portion of a corresponding one of said pair of elongated rails, said mobile elements supporting said APU.

8. The auxiliary power system of claim 7, wherein said at least two mobile elements are configured to roll across said elongated rails.

9. The auxiliary power system of claim 7, further comprising:
a housing surrounding said APU; and
an access door pivotably connected to said housing so that said door is pivotable between a closed position enclosing said APU within said housing and an open position at which said APU is accessible outside said housing.

10. The auxiliary power system of claim 9, wherein said access door has an interior surface configured to movably support said at least two mobile elements, and further wherein said access door is pivotably connected to said housing so that said interior surface is substantially aligned with said pair of elongated rails so that said APU can move from said rails onto said access door.

11. The auxiliary power system of claim 10, wherein said at least two mobile elements are configured to be lifted off said access door to permit removal of said APU therefrom.

12. The auxiliary power system of claim 11, further comprising:
cables and/or hoses associated with components of said APU;
corresponding cables and/or hoses associated with the vehicle; and
quick disconnect couplings between said cables and/or hoses and said corresponding cables and/or hoses.

13. An auxiliary power system for a vehicle having a frame comprising:
an internal combustion engine supported on the vehicle frame, said engine having an exhaust manifold through which engine exhaust gases are expelled; and
a heat exchanger including;
a central tube connected to said exhaust manifold for receiving the exhaust gases;
a jacket surrounding said central tube, said jacket configured to form a fluid circuit with a heating system associated with the vehicle, said jacket having a fluid inlet for receiving a fluid to be heated and a fluid outlet for delivering the heated fluid to the vehicle heating system,
wherein said central tube is configured to permit heat exchange between the exhaust gases flowing therethrough and fluid circulating through said jacket.

14. The auxiliary power system of claim 13, further comprising a cleaning auger rotatably disposed within said central tube and having a surface contacting or closely adjacent said central tube to remove residue on said tube.

15. The auxiliary power system of claim 14, wherein said cleaning auger includes a brush array configured to contact said central tube.
